(19) United States
(12) Patent Application Publication
(10) Pub. No.: US 2003/0117118 A1
(43) Pub. Date: Jun. 26, 2003

(54) Switching power supply and control circuit used therefor

(75) Inventors: Takakazu Imai, Chuo-ku (JP); Takeshi Uematsu, Chuo-ku (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Chuo-ku (JP)

(21) Appl. No.: 10/324,869

(22) Filed: Dec. 19, 2002

(30) Foreign Application Priority Data
Dec. 26, 2001 (JP) 2001-393795

(51) Int. Cl. G05F 1/40

(52) U.S. Cl. 323/282

(57) ABSTRACT

A switching power supply which can obtain high accuracy of the output voltage without increasing the clock frequency is disclosed. A switching power supply according to the present invention employs an output detector for detecting an output voltage Vo of the switching power supply and a signal generator for generating a switching control signal SW based on the output voltage Vo of the switching power supply. The switching control signal SW includes during each control period Tc a plurality of pulses each having either a first pulse width or a second pulse width different from the first pulse width. According to the present invention, the accuracy of the output voltage Vo can in effect be enhanced by controlling the number of the pulses having the second pulse width in each control period.

### BACKGROUND OF THE INVENTION

The present invention relates to a switching power supply and a control circuit used therefor, and more specifically, to a digitally controlled switching power supply and a control circuit that digitally control a switching power supply.

### DESCRIPTION OF THE PRIOR ART

The DC/DC converter is a well-known switching power supply. The typical DC/DC converter uses a switching circuit to once convert a direct current input to an alternating current, and uses an output circuit to convert the alternating current to direct current. The DC/DC converter thus provides a DC output of a different voltage from the input voltage.

The switching power supply of this type is equipped with a control circuit that detects the output voltage and controls the switching operation of the switching circuit based on the detected value. This enables the switching power supply to supply a stable operating voltage to the driven load.

In recent years, many efforts have been made to digitize at least a part of the control circuit used for the switching power supply. Since unlike analog control, which utilizes continuous values, digital control utilizes discrete values, the minimum operation pitch depends on the frequency of the clock signal (clock frequency). Therefore, a clock signal of high frequency must be used to enable precision control.

However, the clock frequency cannot be increased to infinity, and electric power consumption increases in proportion to the clock frequency. Thus, it is desired that the control circuit for the switching power supply be able to perform precision control without increasing the clock frequency.

### SUMMARY OF THE INVENTION

It is therefore an object of the present invention to provide a control circuit for a switching power supply that can achieve precision control without increasing clock frequency.

Another object of the present invention is to provide a switching power supply employing such a control circuit.

The above and other objects of the present invention can be accomplished by a control circuit for digitally controlling a switching power supply comprising:

an output detector for detecting an output voltage of the switching power supply; and

a signal generator for generating a switching control signal based on the output voltage of the switching power supply, the switching control signal including during each control period a plurality of pulses each having either a first pulse width or a second pulse width different from the first pulse width.

According to the present invention, because the switching control signal includes during each control period a plurality pulses each having either the first pulse width or the second pulse width, the accuracy of the output voltage can in effect be enhanced by controlling the number of the pulses having the second pulse width in each control period. Thus, the control circuit of the present invention can precisely control the switching power supply without increasing the clock frequency.

In a preferred aspect of the present invention, a difference between the first and second pulse widths is equal to one period of a clock signal.

In a further preferred aspect of the present invention, the signal generator determines the first pulse width based on a result of detecting the output voltage of the switching power supply at a first accuracy and determines a number of pulses having the second pulse width based on a result of detecting the output voltage of the switching power supply at a second accuracy that is more precise than the first accuracy.

In a further preferred aspect of the present invention, the signal generator determines the first pulse width based on a quotient obtained by dividing a digitized value of the output voltage and determines the number of pulses having the second pulse width based on a remainder of the division.

In a further preferred aspect of the present invention, the signal generator divides the control period into a plurality of sub-control periods of identical contents.

According to this preferred aspect of the present invention, because a maximum period of appearance of a switching control signal including the second pulse width is shortened, occurrence of a ripple having a long period in the output voltage of the switching power supply is effectively avoided.

The above and other objects of the present invention can be also accomplished by a switching power supply, comprising:

a switching circuit for performing a switching operation based on a switching control signal;

an output circuit for receiving an output voltage of the switching circuit; and

a control circuit for generating the switching control signal based on the output voltage of the output circuit, the switching control signal including during each control period a plurality of pulses each having either a first pulse width or a second pulse width different from the first pulse width.

The above and other objects and features of the present invention will become apparent from the following description made with reference to the accompanying drawings.

### BRIEF DESCRIPTION OF THE DRAWINGS

FIG. 1 is a timing chart showing a switching control signal SW, for explaining why the minimum operation pitch depends on the clock frequency.

FIG. 2 is a circuit diagram showing a switching power supply that is a preferred embodiment of the present invention.

FIG. 3 is a circuit diagram showing the pulse width controller 34 shown in FIG. 2.

FIG. 4 is a timing chart schematically showing the comparison operation by a comparator 36.

FIG. 5 is a circuit diagram showing a switching power supply that is another preferred embodiment of the present invention.

### DESCRIPTION OF THE PREFERRED EMBODIMENTS

In advance of explaining preferred embodiments of the present invention, the reason why the minimum operation pitch depends on the clock frequency in a conventional control circuit for digitally controlling a switching power supply will be explained.

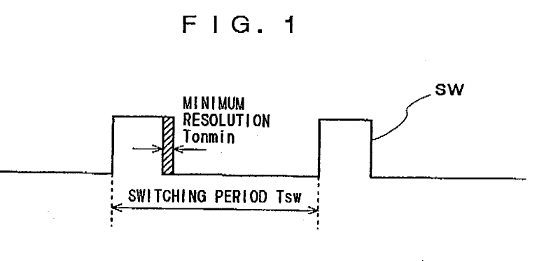

FIG. 1 is a timing chart showing a switching control signal SW, which will be used to explain why the minimum operation pitch depends on the clock frequency.

In digital control of the switching power supply, the output voltage Vo of the switching power supply is determined by the pulse width of the switching control signal SW generated by the control circuit. As shown by Equation (1), the minimum resolution Tonmin of the switching control signal SW is equal to one period of the clock signal (clock frequency=fs).

$$Tonmin = \frac{1}{{f}_{s}} \qquad ( 1 )$$

Therefore, the pulse widths (Qcount) of the switching control signal SW that can be assumed during each switching period Tsw are limited as shown by Equation (2). Thus, the minimum control pitch ΔVo of the output voltage Vo is limited as shown by Equation (3).

$$\begin{matrix}Qcount = \frac{Tsw}{Tonmin} & ( 2 ) \\ Δ Vo = \frac{Vin}{Qcount} & ( 3 )\end{matrix}$$

For example, in the case where the frequency fs of the clock signal is 40 MHz, the switching period Tsw is 2.51 sec (switching frequency fsw=400 KHz), and the input voltage Vin is 12V, then the minimum control pitch ΔVo of the output voltage Vo is 0.12V.

Although not shown in FIG. 1, the pulse width of the switching control signal SW is reassessed and changed in view of the actual value of the output voltage Vo each control period Tc, whose duration is several hundreds times that of the switching period Tsw. That is, the pulse width of the switching control signal SW is fixed during any given control period Tc. In the above example, the output voltage Vo is controlled at a pitch of 0.12V during each control period Tc. Therefore, in the case where the output voltage Vo is set to a relatively low value of, for example, 1V, such as in a switching power supply for a CPU (central processing unit), the accuracy of the output voltage (ΔVo/Vo) becomes very low, ±12% in the above example.

As can be seen from Equation (3), in order to enhance the accuracy of the output voltage (ΔVo/Vo) by reducing the minimum control pitch ΔVo, Qcount must be increased. In order to increase Qcount, it is necessary to increase the clock frequency fs, as is apparent from Equations (1) and (2); however, increasing the clock frequency fs involves various difficulties. Moreover, when the clock frequency fs is increased, electric power consumption increases.

As explained above, in the digital control for the switching power supply, the minimum control pitch ΔVo depends on the clock frequency fs. The present invention makes it possible to in effect enhance the accuracy of the output voltage without changing the minimum control pitch ΔVo. Preferred embodiments of the present invention now will be explained.

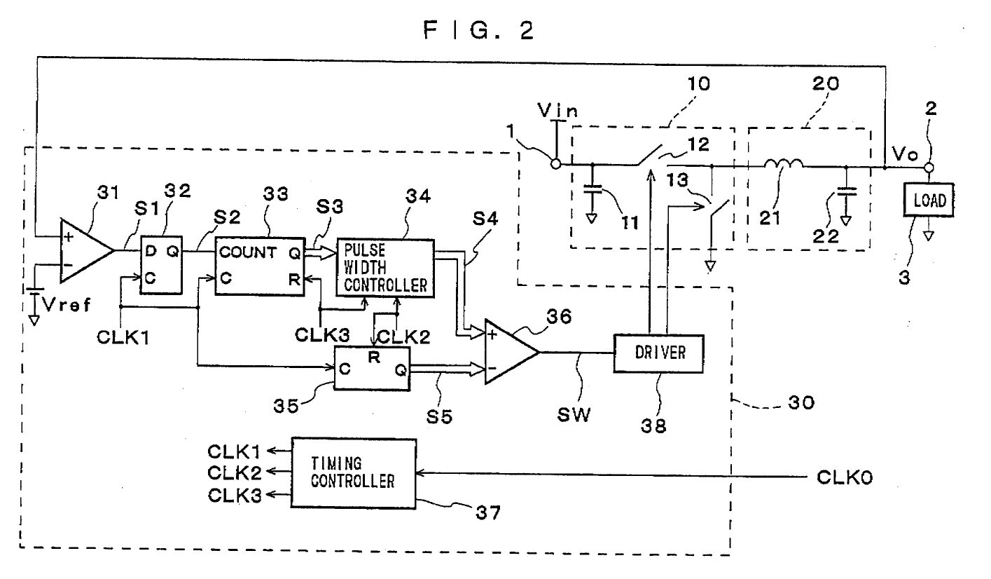

FIG. 2 is a circuit diagram showing a switching power supply that is a preferred embodiment of the present invention.

As shown in FIG. 2, the switching power supply of this embodiment can lower a DC (direct current) input voltage Vin supplied to an input power terminal 1 to generate a DC output voltage Vo and supply the DC output voltage Vo to an output power terminal 2. The switching power supply of this embodiment is composed of a switching circuit 10, an output circuit 20 and control circuit 30. A DC load 3, a CPU for example, can be connected to the output power terminal 2. Because the merit of using the switching power supply of this embodiment increases with decreasing output voltage Vo, it is suitable for driving a load with a low operation voltage, such as a CPU.

The switching circuit 10 is composed of an input capacitor 11 and switching elements 12 and 13. The input capacitor 11 is connected between the input power terminal and ground potential and can stabilize the input voltage Vin. The switching element 12 is connected between the input capacitor 11 and the output circuit 20 and the switching element 13 is connected between the switching element 12 and ground potential. The switching elements 12 and 13 are brought into ON state in turn under the control of the control circuit 30.

The output circuit 20 is composed of an output reactor 21 and an output capacitor 22. The output reactor 21 is connected between the switching circuit 10 and the output power terminal 2. The output capacitor 22 is connected between the output power terminal 2 and ground potential.

The control circuit 30 is composed of comparators 31 and 36, a latch circuit 32, counters 33 and 35, a pulse width controller 34, a timing controller 37, and a driver 38. Among the components of the control circuit 30, the latch circuit 32, the counters 33 and 35, the pulse width controller 34 and the timing controller 37 neither utilize analog signals nor require large driving capability., At least these components are therefore preferably integrated in a single semiconductor chip. However, this is not a requirement of the present invention.

The timing controller 37 is a circuit for generating timing signals CLK1, CLK2 and CLK3 based on an external timing signal CLK0. In this embodiment, the frequency of the timing signal CLK1 is equal to that of the external timing signal CLK0, the frequency of the timing signal CLK2 is equal to the switching frequency fsw′, and the frequency of the timing signal CLK3 is equal to the control frequency fc. In this specification, one period of the timing signal CLK1(1/fs) is referred to as a “clock period (Ts)”, one period of the timing signal CLK2 (1/fst) is referred to as a “switching period (Tsw)”, and one period of the timing signal CLK3 (1/fc) is referred to as a “control period (Tc)”.

Since the timing signal CLK1 is a base clock for the control circuit 30, the frequency of the timing signal CLK1 must be sufficiently high relative to the switching frequency fsw. Here, the switching period Tsw(=1/fsw) is equal to the operation period of the switching elements 12 and 13. The control for the switching elements 12 and 13 is reassessed in view of the actual value of the output voltage Vo each control period Tc (=1/fc). The relationship among the clock frequency fs, switching frequency fsw and control frequency fc is not limited but it is preferably set as follows:

fs=100×fsw

fsw=300×fc

Specifically, it is preferable that the frequencies of the timing signals CLK1, CLK2 and CLK3 be set to around 40 MHz, 400 KHz, and 1.33 KHz, respectively. In this case, the clock period Ts, switching period Tsw, and control period Tc become 25 nsec, 2.5 μsec, and 750 μsec, respectively.

The comparator 31, which is an output detector for detecting the output voltage Vo of the switching power supply, has an inverted input terminal (−) receiving a reference voltage Vref that is the desired voltage of the output voltage Vo and a non-inverted input terminal (+) connected to the output power terminal 2 to receive the output voltage Vo. Thus, comparator 31 sets an output signal S1 to high level (1) when the actual value of the output voltage Vo is higher than the reference voltage Vref and sets the output signal S1 to low level (0) when the actual value of the output voltage Vo is lower than the reference voltage Vref.

The latch circuit 32 is of the so-called data latch type (D-type) and has a data input terminal (D), a clock input terminal (C), and a data output terminal (Q). The data input terminal (D) receives the output signal S1 generated by the comparator 31, and the clock input terminal (C) receives the timing signal CLK1 generated by the timing controller 37. The operation of the latch circuit 32 is the same as that of an ordinary latch circuit of data latch type. Specifically, the latch circuit 32 latches the logical value of the output signal S1 supplied to the data input terminal (D) at the time the timing signal CLK1 supplied to the clock input terminal (C) is produced, and outputs an output signal S2 having the latched logical value from the data output terminal (Q).

The counter 33 has a count terminal (COUNT) receiving the output signal S2, a clock input terminal (C) receiving the timing signal CLK1, a reset terminal (R) receiving the timing signal CLK3, and a data output terminal (Q). When the logical value of the output signal S2 supplied to the count terminal (COUNT) is “1 (high level )” at the time the timing signal CLK1 supplied to the clock input terminal (C) is produced, the counter 33 counts up, i.e., increments its internal register (not shown), and outputs an output signal S3 having the count value from the data output terminal (Q). When the timing signal CLK3 supplied to the reset terminal (R) is produced, the count value of the counter 33 is reset to zero.

Thus, if the frequencies of the timing signals CLK1 and CLK3 are 40 MHz and 1.33 KHz, respectively, the output signal S3 (count value) can take values between 0 and 30,000.

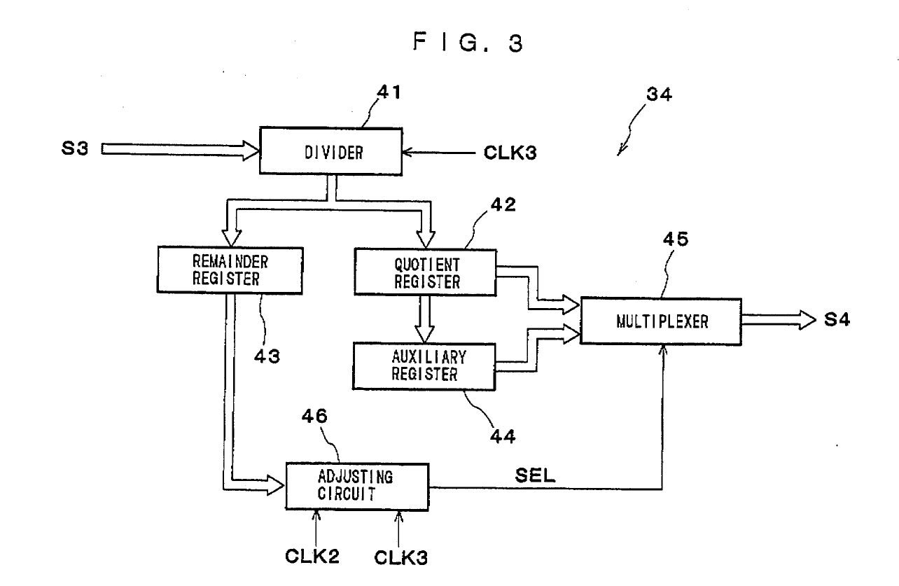

FIG. 3 is a circuit diagram showing the pulse width controller 34.

As shown in FIG. 3, the pulse width controller 34 is composed of a divider 41, a quotient register 42, a remainder register 43, an auxiliary register 44, a multiplexer 45, and an adjusting circuit 46.

The divider 41 receives the output signal S3 (count value) from the counter 33 and divides it by a ratio of the switching frequency and the control frequency (fsw/fc) at the time the timing signal CLK3 is produced. The quotient and the remainder obtained by the division are stored in the quotient register 42 and the remainder register 43, respectively.

Thus, if the frequency of the timing signals CLK1, CLK2, and CLK3 are 40 MHz, 400 KHz, and 1.33 KHz, respectively, the quotient can take values between 0 and 100 and the remainder can take values between 0 and 299 because the divider 41 divides the output signal S3 (count value) by 300.

The auxiliary register 44 stores the value obtained by adding “1” to the value stored in the quotient register 42.

The multiplexer 45 is a circuit for selecting one or the other of the values stored in the quotient register 42 and the auxiliary register 44 based on a selection signal SEL. The selected value is supplied to the comparator 36 as an output signal S4. In this embodiment, the value stored in the quotient register 42 is selected when the logical value of the selection signal SEL is “0” and the value stored in the auxiliary register 44 is selected when the logical value of the selection signal SEL is “1”.

The adjusting circuit 46 is a circuit for generating the selection signal SEL based on the value stored in the remainder register 43. Detailed operation of the adjusting circuit 46 will now be explained.

As shown in FIG. 3, the adjusting circuit 46 receives the timing signals CLK2 and CLK3 generated by the timing controller 37 and determines the logical value of the selection signal SEL for each control period based on the value stored in the remainder register 43 and the timing signal CLK2 by checking the remainder register 43 each time the timing signal CLK3 is produced. Specifically, assuming that the value stored in the remainder register 43 and checked by the adjusting circuit 46 is m, the adjusting circuit 46 sets the selection signal SEL to the logical value of “1” during m switching periods in total and sets the selection signal SEL to the logical value of “0” during the other periods in this control period.

Because the remainder register 43 stores the remainder obtained by dividing the output signal S3 (count value) by the ratio of the switching frequency and the control frequency (fsw/fc), if the remainder takes a maximum value ((fsw/fc)−1), the logical value of the selection signal SEL is set to “0” during one switching period in this control period and is set to “1” during the other periods ((fsw/fc)−2)×Tsw). And if the remainder takes a minimum value (0), the logical value of the selection signal SEL is set to “0” during all switching periods in this control period.

It is desirable to disperse the periods at which the logical value of the selection signal SEL takes a value of “1” within the same control period. For example, if the value stored in the remainder register 43 is fsw/2fc (150 in the above example), it is preferable that the logical value of the selection signal SEL be alternately set to “0” and “1”. Similarly, if the value stored in the remainder register 43 is fsw/3fc (100 in the above example), it is preferable that the logical value of the selection signal SEL be set to “1” every third switching period and be set to “0” during the other switching periods. Further, if the value stored in the remainder register 43 is 2fsw/3fc (200 in the above example), it is preferable that the logical value of the selection signal SEL be set to “0” every third switching period and be set to “1” during the other switching periods.

As shown in FIG. 2, the counter 35 has a clock input terminal (C) receiving the timing signal CLK1, a reset terminal (R) receiving the timing signal CLK2, and a data output terminal (Q). The counter 35 increments its internal register (not shown) each time the timing signal CLK1 is supplied to the clock input terminal (C) and outputs an output signal S5 having the count value from the data output terminal (Q). When the timing signal CLK2 supplied to the reset terminal (R) is produced, the count value of the counter 35 is reset to zero.

Thus, if the frequency of the timing signals CLK1 and CLK2 are 40 MHz and 400 KHz, respectively, the output signal S5 (count value) can take values between 0 and 100.

The comparator 36 has an inverted input terminal (−) receiving the output signal S5 supplied from the counter 35 and a non-inverted input terminal (+) receiving the output signal 84 supplied from the pulse width controller 34. Thus, the comparator 36 sets a switching control signal SW to high level (1) when the output signal 54 is equal to or greater than the output signal S5 and sets switching control signal SW to low level (0) when the output signal S4 is smaller than the output signal S5.

The control circuit 30, the latch circuit 32, counter 33, pulse width controller 34, counter 35, and comparator 36 thus constitute a signal generator for generating the switching control signal SW.

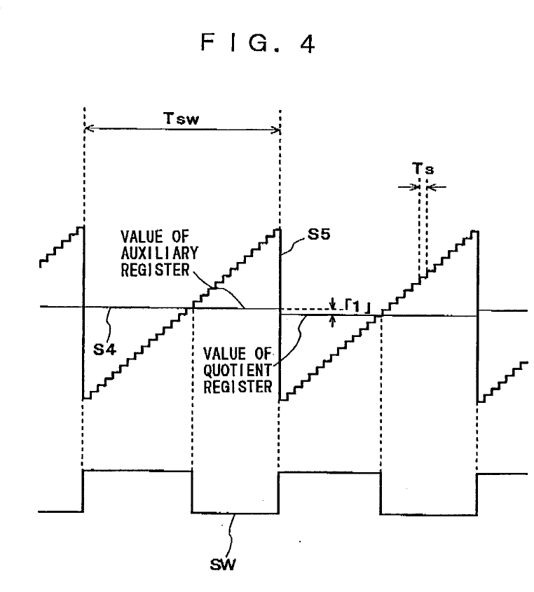

FIG. 4 is a timing chart schematically illustrating the comparison operation by comparator 36. Although FIG. 4 shows the comparison operation in an analog manner for convenience of illustration, the comparator 36 is a digital circuit for comparing the digital output signals S4 and S5 and actually compares them digitally.

As explained earlier, the value of the output signal S5, which is the count value of the counter 35, increases in response to the timing signal CLK1 and is reset in response to the timing signal CLK2. Therefore, when the value of the output signal S5 is indicated in an analog manner, it has a sawtooth waveform. On the other hand, the value of the output signal S4, which is the output of the pulse width controller 34, takes one or the other of the values stored in the quotient register 42 and the auxiliary register 44 (quotient+1). Because the pulse width of the switching control signal SW is determined based on the period during which the output signal S4 is equal to or greater than the output signal S5, the pulse width of the switching control signal SW becomes one of two pulse widths: a width determined based on the value stored in the quotient register 42 (first pulse width) and a width determined based on the value stored in the auxiliary register 44 (second pulse width).

The difference between the first pulse width and the second pulse width is the minimum control width defined by the clock frequency fs of the clock signal CLK1, so that it is equal to the clock period Ts. The number of pulses of the switching control signal SW that have the second pulse width is equal to the value stored in the remainder register 43.

The driver 38 sets the switching element 12 to ON state and the switching element 13 into OFF state while the switching control signal SW is at high level, and sets the switching element 12 to OFF state and the switching element 13 to ON state while the switching control signal SW is at low level. It is worth noting that a dead time is inserted to prevent the switching elements 12 and 13 from turning ON simultaneously.

Therefore, the switching circuit 10 performs a switching operation so as to stabilize the output voltage Vo at the reference voltage Vref under the control of the control circuit 30. In this switching operation, because the pulse width of the switching control signal SW in the same control period Tc is not fixed but varied in minimum control width based on the value stored in the remainder register 43, the accuracy of the output voltage is in effect enhanced.

Specifically, because the number of the pulses of the switching control signal SW which have the second pulse width in each control period Tc can take values between 0 and (fsw/fc)−1, the minimum control pitch ΔVo′ of the output voltage Vo in each control period Tc can be represented by Equation (4).

$$Δ {Vo}^{′} = \frac{Vin \times fsw}{fs} \times \frac{fc}{fsw} \qquad ( 4 )$$

Thus, if the frequency of the timing signals CLK1, CLK2, and CLK3 are 40 MHz, 400 KHz, and 1.33 KHz, respectively, and the input voltage Vin is 12V, then the minimum control pitch ΔVo′ of the output voltage Vo in each control period Tc becomes 0.0004V, making it possible to control the output voltage Vo with very high accuracy.

In this case, the minimum control pitch αVo of the output voltage Vo in each switching period Tsw (0.12V in the above example) still depends on the timing signal CLK1. In the conventional switching power supply, however, because the pulse width of the switching control signal SW is fixed in any given control period Tc, the minimum control pitch αVo in each switching period Tsw, which determines the accuracy of the actual output voltage, is equal to the minimum control pitch ΔVo′ in each control period Tc. In contrast, according to the switching power supply of this embodiment, extremely high accuracy can be obtained because the minimum control pitch ΔVo′ in each control period Tc is very small.

As described above, according to the switching power supply of this embodiment, because the pulse width of the switching control signal SW is finely controlled in each control period Tc, extremely high accuracy of the output voltage can be obtained without increasing the clock frequency. Therefore, the switching power supply of this embodiment is particularly suitable for driving a DC load 3 having a low operation voltage, such as a CPU.

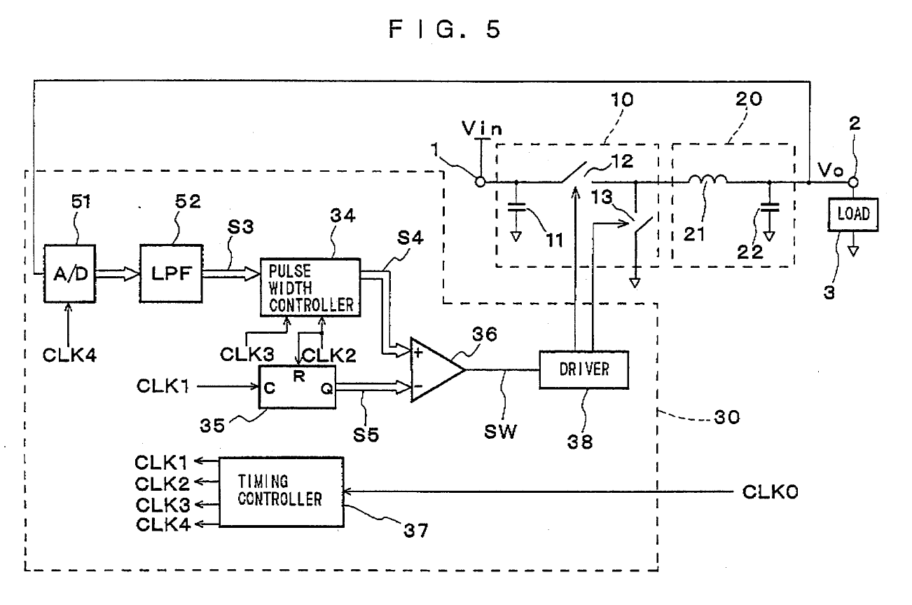

FIG. 5 is a circuit diagram showing a switching power supply that is another preferred embodiment of the present invention.

As shown in FIG. 5, the switching power supply of this embodiment is different from the switching power supply shown in FIG. 1 in that an A/D converter 51 and a low pass filter 52 are employed in the control circuit 30 instead of the comparator 31, latch circuit 32, and counter 33 and in that the timing controller 37 also generates a timing signal CLK4. In aspects other than these, the switching power supply of this embodiment has the same configuration as the switching power supply shown in FIG. 1. Explanation of like elements will therefore be omitted.

The A/D converter 51 is connected to the output power terminal 2 so as to receive the output voltage Vo. It converts the output voltage Vo into a digital value each time the timing signal CLK4 is produced. The frequency of the timing signal CLK4 is required to be higher than the control frequency fc. The frequency of the timing signal CLK4 is preferably several tens to several hundred of times higher than the control frequency fc, and still more preferably the frequency of the timing signal CLK4 is higher than the switching frequency fsw. The low pass filter 52 levels the digital value supplied from the A/D converter 51. As shown in FIG. 5, a digital value leveled by the low pass filter 52 is used as the output signal S3 which is supplied to the pulse width controller 34 similarly to the switching power supply shown in FIG. 1.

According to the switching power supply of this embodiment, the output voltage Vo can be detected more accurately by means of setting the timing signal CLK4 considerably high.

The present invention has thus been shown and described with reference to specific embodiments. However, it should be noted that the present invention is in no way limited to the details of the described arrangements but changes and modifications may be made without departing from the scope of the appended claims.

For example, each control period Tc can be divided into a plurality of sub-control periods Tcsub each of which is N (N being the quotient of dividing fsw/fc by an integer) times longer than one switching period Tsw, and the same operation can be repeatedly performed at each sub-control period Tcsub included in the same control period Tc. Also in this case, the pulse width of the switching control signal SW is selected as either the first pulse width or the second pulse width based on the output voltage Vo in the same sub-control period Tcsub. According to this control, although the accuracy of the output voltage is degraded compared with the earlier embodiments, the maximum period during which the puke of the switching control signal SW having the second pulse width appears is shortened compared with the above embodiments, so that filtering by the output reactor 21 and the output capacitor 22 is facilitated.

The above operation can be performed by dividing the value stored in the remainder register 43 by fsw/(fc×N) using the adjusting circuit 46 shown in FIG. 3, and deciding the logical value of the selection signal SEL in each switching period Tsw in the same sub-control period Tcsub based on the quotient obtained by the division and the timing signal CLK2. Specifically, assuming that the quotient obtained by the division is m′, the adjusting circuit 46 sets the selection signal SEL to the logical value of “1” during m′ switching periods in total in the same sub-control period Tcsub and sets the selection signal SEL to the logical value of “0” during the other periods in this sub-control period Tcsub, and such operation is repeated in the same control period Tc.

Further, in the foregoing embodiments, a back converter circuit is used for the switching circuit 10. However, the switching circuit 10 is not limited to the back converter circuit and other converter circuits can be used instead.

Furthermore, in the foregoing embodiments, the switching circuit 10 and the output circuit 20 are not isolated. However, the present invention can be applied to a switching power supply of isolated type using a transformer.

Further, in the switching power supply shown in FIG. 1, the counter 33 is reset in response to the timing signal CLK3. If the count value in the counter 33 is not discarded immediately, however, it is possible to use a moving average of a plurality of count values in the counter 33 as the output signal S3.

Furthermore, the switching power supply of either of the foregoing embodiments, the output signal S3 is divided using the divider 41. However, the division can be omitted if the upper bits of the output signal S3 are stored in the quotient register 42 and the remaining lower bits of the output signal S3 are stored in the remainder register 43.

As described above, according to the switching power supply of the present invention, high accuracy of the output voltage can be obtained in a simple manner without increasing the clock frequency. Therefore, the switching power supply of the present invention is particularly suitable for driving a load with a low operation voltage, such as a CPU.

1. A control circuit for digitally controlling a switching power supply, comprising:
an output detector for detecting an output voltage of the switching power supply; and
a signal generator for generating a switching control signal based on the output voltage of the switching power supply, the switching control signal including during each control period a plurality of pulses each having either a first pulse width or a second pulse width different from the first pulse width.

2. The control circuit as claimed in claim 1, wherein a difference between the first and second pulse widths is equal to one period of a clock signal.

3. The control circuit as claimed in claim 1, wherein the signal generator determines the first pulse width based on a result of detecting the output voltage of the switching power supply at a first accuracy and determines a number of pulses having the second pulse width based on a result of detecting the output voltage of the switching power supply at a second accuracy that is more precise than the first accuracy.

4. The control circuit as claimed in claim 2, wherein the signal generator determines the first pulse width based on a result of detecting the output voltage of the switching power supply at a first accuracy and determines a number of pulses having the second pulse width based on a result of detecting the output voltage of the switching power supply at a second accuracy that is more precise than the first accuracy.

5. The control circuit as claimed in claim 3, wherein the signal generator determines the first pulse width based on a quotient obtained by dividing a digitized value of the output voltage and determines the number of pulses having the second pulse width based on a remainder of the division.

6. The control circuit as claimed in claim 4, wherein the signal generator determines the first pulse width based on a quotient obtained by dividing a digitized value of the output voltage and determines the number of pulses having the second pulse width based on a remainder of the division.

7. The control circuit as claimed in claim 1, wherein the signal generator divides the control period into a plurality of sub-control periods of identical contents.

8. A switching power supply, comprising:
a switching circuit for performing a switching operation based on a switching control signal;
an output circuit for receiving an output voltage of the switching circuit; and
a control circuit for generating the switching control signal based on the output voltage of the output circuit, the switching control signal including during each control period a plurality of pulses each having either a first pulse width or a second pulse width different from the first pulse width.

9. The switching power supply as claimed in claim 8, wherein a difference between the first and second pulse widths is equal to one period of a clock signal.

10. The switching power supply as claimed in claim 8, wherein the control circuit determines the first pulse width based on a result of detecting the output voltage of the output circuit at a first accuracy and determines a number of pulses having the second pulse width based on a result of detecting the output voltage of the output circuit at a second accuracy that is more precise than the first accuracy.

11. The switching power supply as claimed in claim 9, wherein the control circuit determines the first pulse width based on a result of detecting the output voltage of the output circuit at a first accuracy and determines a number of pulses having the second pulse width based on a result of detecting the output voltage of the output circuit at a second accuracy that is more precise than the first accuracy.

12. The switching power supply as claimed in claim 10, wherein the control circuit determines the first pulse width based on a quotient obtained by dividing a digitized value of the output voltage of the output circuit and determines the number of pulses having the second pulse width based on a remainder of the division.

13. The switching power supply as claimed in claim 11, wherein the control circuit determines the first pulse width based on a quotient obtained by dividing a digitized value of the output voltage of the output circuit and determines the number of pulses having the second pulse width based on a remainder of the division.

14. The switching power supply as claimed in claim 8, wherein the control circuit divides the control period into a plurality of sub-control periods of identical contents.
